(19) United States
(12) Patent Application Publication
(10) Pub. No.: US 2008/0284185 A1
(43) Pub. Date: Nov. 20, 2008

(54) Harbormaster

(76) Inventor: Steven Joseph Pixley, Camden, ME (US)

Correspondence Address: Steven Pixley, 361 Hosmer Pond Road, Camden, ME, 04843, US

(21) Appl. No.: 11/688,909

(22) Filed: May 14, 2007

(51) Int. Cl. B66C 1/42

(52) U.S. Cl. 294/66.1

(57) ABSTRACT

The invention concerns a method and a devise for hauling chain from under the water without the use of an under water diver. This devise can be used from a boat or a barge and only needs one person for operation. This new design consists of an angled housing with a large opening and a slot. Because of a hinge, this housing opens up at one end and goes around any chain that is leading underwater. Because the design has a specific weight distribution the tool slides down the chain keeping the chain against the hauling end of the tool where the hole in the housing is bigger than the chain. When the tool is at the desired depth the line is hauled back up and because of the twenty degree bend in the housing, the chain automatically is hooked inside the slot or weighted end.

The inside of this tool looks like a teardrop. The end of the tool which is weighted is the thin part of the teardrop or the slot and faces down and away from the chain as it falls. Instead the fat rounded side slides down the chain until the bottom is reached. Due to a 20° bend in the tool the chain becomes hooked when the lifting line is hauled. The chain and any type of anchor can be brought to the surface in a fraction of the time with the use of “The Harbor Master”.

### BACKGROUND OF THE INVENTION

This invention deals with the inefficiencies of hauling chain up from a lower area to a higher area. This invention pertains to the field of marine chain hauling. All municipal Harbormasters have to move and inspect moorings and the chains attached to them. This task is done by using a hydraulic pot hauler and a hauling line. After the mooring ball is hauled on board a line is tide to the chain at the waterline and hauled until the chain hits the hauling wheel. At this time a holding line must be tide to take the load while the hauling line is untied and retied at the waterline. This process is repeated until the mushroom anchor or granite block is raised out of the water and placed on board. This process is both time consuming and dangerous. Private aids to navigation or channel markers must be taken out for the winter and this process for taking them out is the same as above. Marine inspectors have to inspect where the top chain is shackled to the heavier bottom chain and this task is accomplished the same tiresome way.

### BRIEF SUMMARY OF THE INVENTION

This new invention is designed to quickly clasp around any chain and sink under water until it reaches a desired destination at which time, when it is hauled back up, it efficiently grabs the chain safely and facilitates lifting. This is done in a fraction of the time and in a safer manner.

### BRIEF DESCRIPTION OF THE VIEWS OF THE DRAWINGS

FIG. 1 is a detailed angle view of the new chain hauling tool showing the new design.

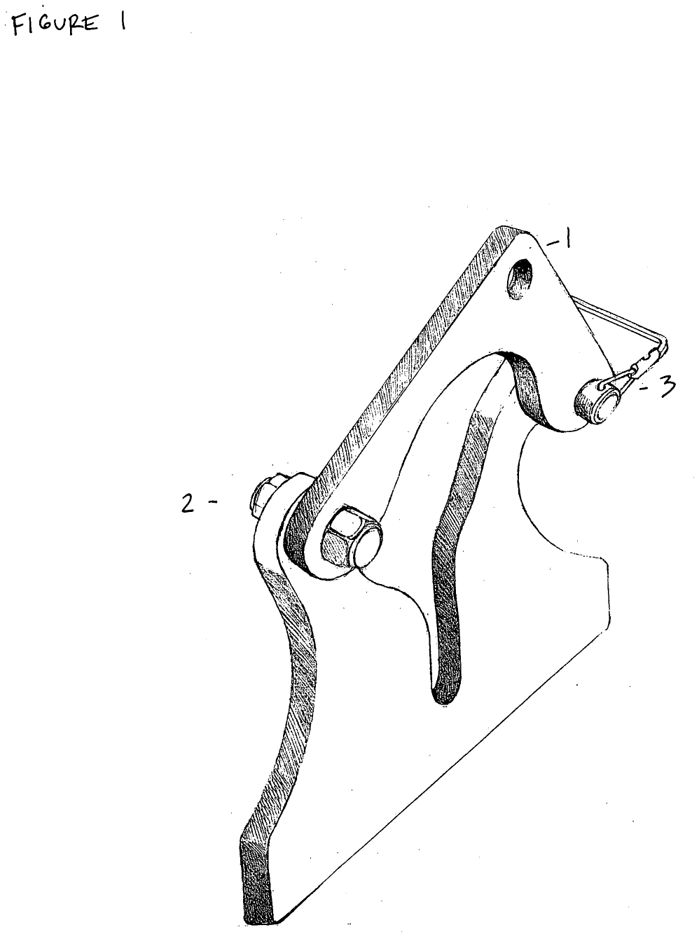

In FIG. 1
1. Shows where the hauling line or hauling wire is attached to.
2. Shows where the top of the housing hinges to open up the tool.
3. Shows the holding pin which is removed to facilitate the opening action.

FIG. 2 is a head on view of the new design as if it were placed on a work bench and looked down on. The tool is shown in the open position.

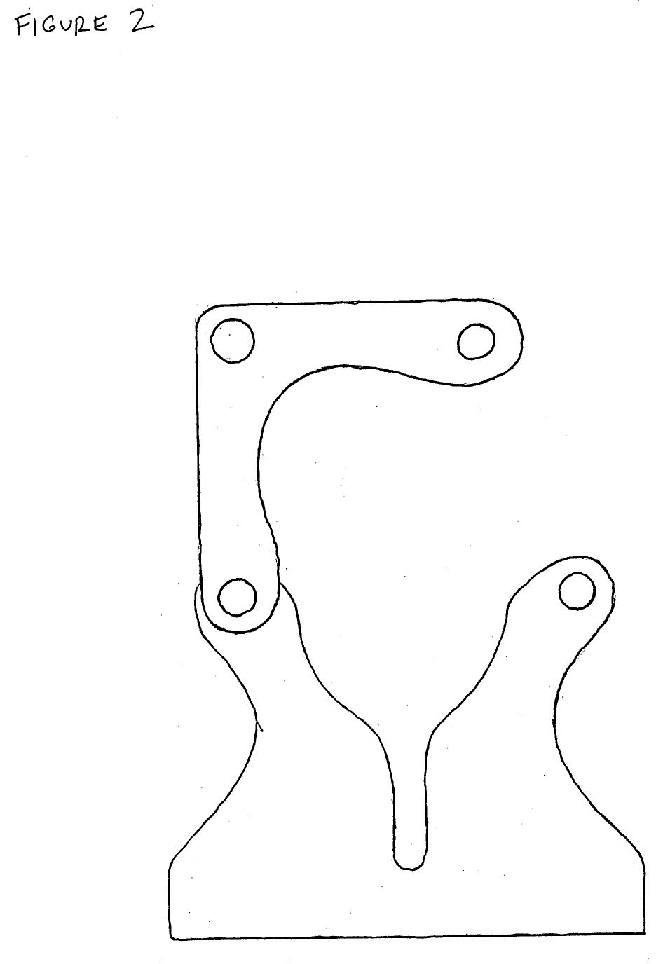

FIG. 3 is a head on view with the tool in the closed position and the holding pin in place.

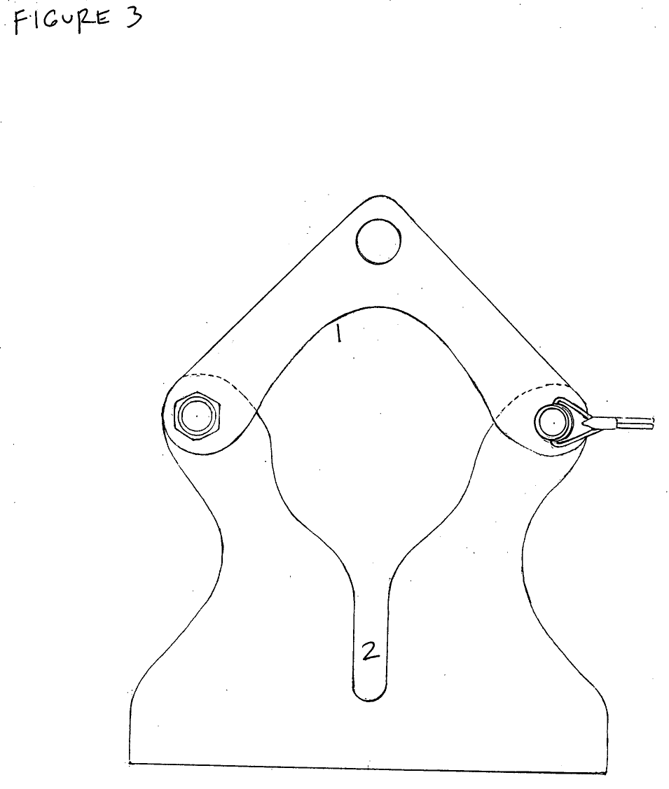

In FIG. 3
1. Shows where the chain rides inside the housing of the tool when the tool is being lowered down the chain.
2. Depicts where the chain automatically hooks into the slot when the tool is hauled back up.

FIG. 4 is a side view of the invention.

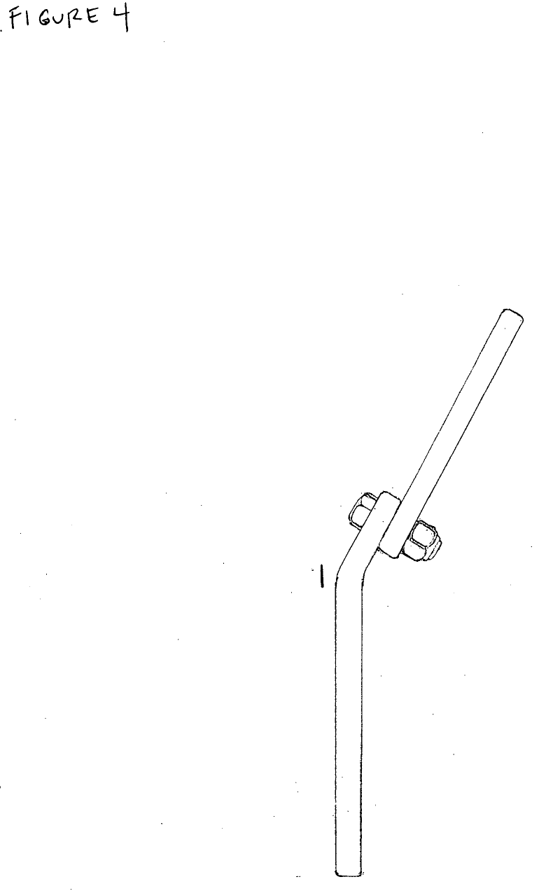

In FIG. 4
1. Shows the twenty degree bend in the lower housing of the tool which is responsible for the tools ability to engage the chain in the slot when being hauled up.

### DETAILED DESCRIPTION OF THE INVENTION

This tool is made of steel or any other durable material that sinks or can be made to sink. This tool is 12″ long and 7″ wide but could be made to any size to fit any size chain. This tool consists of an angled housing with a large opening that surrounds the chain and utilizes a slot to secure the chain and facilitate lifting. This tool has a hinge that facilitates ease of surrounding a chain when the ends of the chain are not easily accessed. This is accomplished by removing a holding pin on the opposite side of the hinged housing and opening the tool and placing it around the chain. This tool has a combination of a specific weight distribution and a twenty degree bend in the housing that allows the tool to be lowered down the chain unmolested and facilitates the efficient engagement of the chain in the slot when the hauling line is pulled back up. A search of the Patent Database proves the tool belonging to U.S. Pat. No. 4,496,181 with a filing date of Apr. 7, 1982 is the closest prior reference to this new invention. Similar to the present invention the prior device includes a large opening that surrounds the chain and utilizes a slot to secure one of the chain links and facilitates lifting.

This invention can be differentiated from the prior U.S. Pat. No. 4,496,181 patent because it includes three additional functions. Specifically, the design of this invention incorporates a hinge, which facilitates installation on chains where access to the end of the chain is impractical.

This new design also has a specific weight distribution which facilitates the correct angle of the tool while it is lowered down the chain.

The third difference is a twenty degree bend that is incorporated into the housing of the invention to guarantee the efficient engagement of the chain in the slot. It is important to note that with out this angle the tool does not engage the chain into the slot when the hauling line is pulled back up.

1. A new method and device for lifting chain from under water without the need of an under water diver where as the new device slides down the chain, until it reaches the anchor, mooring, etc., and when the hauling line is pulled the devise locks the chain into a slot and lifts the load to the surface in one haul.
The under water chain hauling device of claim 1 has the ability, because of a hinge, to be installed on a chain where access to the end of the chain is impractical.
The under water chair hauling device of claim 1 has the ability, because of a specific weight distribution, to be lowered down the chain unmolested until the desired lifting point is reached.
The under water chain hauling tool of claim 1 has the ability, because of a twenty degree bend that is incorporated into the housing, to guarantee the efficient engagement of the chain into the slot when the hauling line is pulled back up.
The under water chain hauling device of claim 1 is made of steel or any material that is durable and can sink or be made to sink
The under water hauling device of claim 1 can be any size to fit any size chain.
